(19) United States
(12) Patent Application Publication
(10) Pub. No.: US 2006/0064312 A1
(43) Pub. Date: Mar. 23, 2006

(54) Method of providing time sensitive information and a system for accomplishing the same

(76) Inventor: Ashok Velji Chandaria, Nairobi (KE)

Correspondence Address: SAND & SEBOLT, AEGIS TOWER, SUITE 1100, 4940 MUNSON STREET, NW, CANTON, OH, 44718-3615, US

(21) Appl. No.: 10/947,822

(22) Filed: Sep. 23, 2004

(51) Int. Cl. G06Q 99/00

(52) U.S. Cl. 705/1; 705/408

(57) ABSTRACT

A method and system for providing time sensitive information by applying an advertisement to an outer surface of a plurality of individual pieces of mail. The advertisement is applied to the individual pieces of mail by either printing it directly onto the outer surface or by adhesively applying a label thereto. The advertiser selects the area to which he wishes to advertise and the advertisement is placed on the mail at the postal station either when the mail is sorted or after the mail is sorted for that zip code or area. Once the individual pieces of mail have the advertisement applied thereto, they are distributed through the postal service's normal channels.

### BACKGROUND OF THE INVENTION

1. Technical Field

This invention generally relates to a method of providing time sensitive information and to a system for accomplishing the same. More particularly, the invention relates to a method of providing time sensitive information through the postal service. Specifically, the invention relates to a method of advertising and to a system that relates to applying an advertisement to the outer surface of individual pieces of mail after they have been mailed and as they are passed through mail sorting machines in a postal station.

2. Background Information

The field of advertising is extremely varied and includes a wide range of vehicles for delivering product and service information to the consuming public. Advertisements are placed on television, on the radio, in newspapers, in magazines, and on billboards, buses and trucks. Other methods of advertising include telephoning consumers to let them know about promotions, putting flyers onto parked vehicles or having flyers delivered to consumers along with their regularly delivered mail. Flyers delivered by mail are frequently referred to by consumers as junk mail and this junk mail tends to annoy consumers because it clutters their mail delivery and buries their personal mail in a mountain of irrelevant paper. The volume of junk mail tends to overwhelm consumers and they frequently do not even read it but simply throw it away. This obviously negates the activity of the advertisers using this form of advertising.

There is therefore a need in the art for delivering time sensitive information through the mail in a way that tends to reduce the sense of being overwhelmed by advertising, will reduce the volume of paper delivered through the mail to consumers and will cause the consumer to stop and read the advertisements they are presented with.

### SUMMARY OF THE INVENTION

The method of providing time sensitive information in accordance with the present invention includes preparing time sensitive information, such as an advertisement, by the customer, selecting areas in which to advertise, transmitting that time sensitive information via electronic means to a central processing unit and on to the postal service, sorting previously mailed pieces of mail by zip code and simultaneously applying the advertisement to the outer surfaces of previously mailed individual pieces of mail; and distributing the mail to the public in the usual manner. The method of providing time sensitive information preferably is zip code specific so that an advertiser can be assured that they are reaching their target market. The system required to achieve this method of providing time sensitive information includes an electronic network, a central processing unit, machinery for sorting the mail, a mechanism for placing the advertisement onto individual pieces of mail and a network for distributing the individual pieces of mail to the public.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a block diagram illustrating the pathway for a first embodiment of the method of providing time sensitive information where the advertisement is printed directly onto individual pieces of mail going to a particular zip code;

FIG. 2 is a block diagram illustrating the pathway for a second embodiment of the method of providing time sensitive information where the advertisement is placed on labels which are applied to mail going to a particular zip code; and

FIG. 3 is a block diagram illustrating the pathway for a third embodiment of the method of providing time sensitive information where the advertisement is transmitted to printing company which prints up labels containing the advertisement and delivers the same to the preselected postal stations.

### DETAILED DESCRIPTION OF THE INVENTION

There are any number of pathways for achieving the purposes of this invention. The methodology of the invention comprises preparing the time sensitive information such as an advertisement, selecting the area in which to advertise, transmitting the advertisement to the postal service, sorting the previously mailed pieces of mail and applying the advertisement to individual pieces of mail going to the selected area to advertise and then delivering the pieces of mail to the public. The actual pathway for achieving the invention may be varied without departing from the scope of the invention. The following description is provided by way of example only and is not meant to limit the invention to only these pathways and related equipment for achieving the invention.

The term “advertisement” as it is used throughout this specification, is used to generally describe any number of messages that a customer wishes to pass on to the consuming public. So, for example, the term may apply to text and/or graphics relating to goods or services for a particular company to make the consuming public aware of the goods, services or simply the company's name. Alternatively, the term may apply to a coupon printed onto the outside of a piece of mail that the consumer may cut out and take to the customer for a discount on goods or services. Furthermore, the term may be used to describe a public service type of message printed onto the mail such as “Don't Drink and Drive” or to make the public immediately aware of a problem such as the abduction of a child.

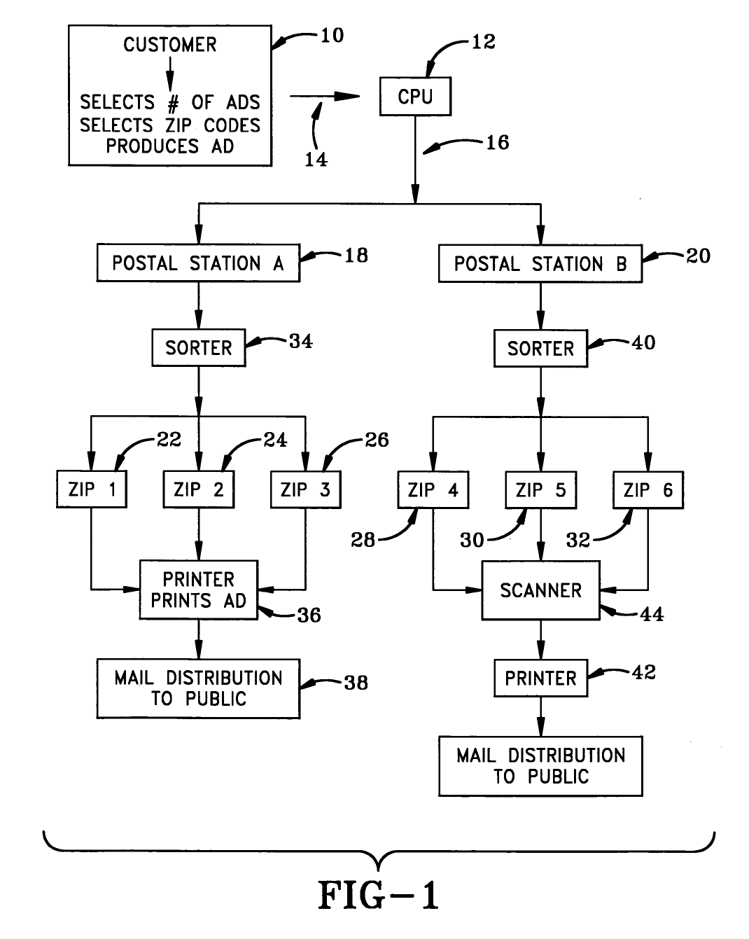

In a first embodiment of the invention, shown in FIG. 1, the customer 10 prepares a suitable advertisement in a format which allows the image to be transmitted electronically. The suitability of the image could be determined by the software selected by the postal service or by a company orchestrating the advertising. One suitable format for the advertisement could be as a JPEG bitmap file. The customer's advertisement could include both text and graphics. Customer 10 selects the various cities, states or zip codes for the: area in which they wish to advertise and they also select the number of advertisements they wish to place or the number of days they wish the campaign to run or the amount of money they wish to expend on this endeavor. Customer 10 contacts a central processing unit (CPU) 12 and electronically transmits 14 the advertisement to the CPU 12 via the Internet. CPU 12 may be located at a postal station designated by the Postal Service, or at an advertising agency or company that offers this type of service. CPU 12 receives the electronic format of the advertisement from customer 10 along with all other relevant information and then transmits as at 16 the same to individual postal stations 18, 20 which distribute mail to a plurality of the zip codes 22, 24, 26, 28, 30 and 32. As may be seen from FIG. 1, the customer may select one or more zip codes at one postal station, e.g. zip code 24 at station 18, or may select one or more zip codes at more than one postal station, e.g. zip codes 22 at postal station 18 and zip code 30 at postal station 20. Mail is sorted at postal stations 18, 20 by mail sorting machines 34 and 40 respectively. Printers 36 and 42 are operatively connected to the mail sorting machines 18, 20 and physically form part of the sorting pathway for the mail. When the electronic transmission 16 is received at the first postal station 18, the advertisement, zip code information and number of advertisements to be placed or length of time for running the advertisement is sent to the sorter 34. Sorter 34 sorts mail for zip codes 22, 24 and 26. If customer 10 wishes to advertise in only the first zip code 22, sorter 34 directs printer 36 to print the advertisement onto the outer surfaces of individual pieces of mail to be delivered to zip code 22. Pieces of mail going to zip codes 24 and 26 will not have the advertisement printed onto them. All of the pieces of mail are then distributed 38 through the normal channels to the public located at zip codes 22, 24 and 26. The system can be set up to automatically print differently sized advertisements onto differently sized envelopes. The operating program can also include software which allows the size of the advertisement to be automatically adjusted to ensure that the advertisement is of the greatest possible size.

As shown with respect to the pathway relating to postal station 20, the system preferably includes a scanner 44 to ensure that the advertisement will not be placed over any part of the delivery or return address on the envelope or over any other advertisement which may have been applied to the outer surface of an individual piece of mail and thereby obscure the advertisement that is to be printed thereon. If scanner 44 determines that a particular piece of mail cannot receive the advertisement in a manner that will allow it to be easily read by the consumer, then that particular piece of mail may be skipped and the advertisement will be printed onto the next suitable piece of mail.

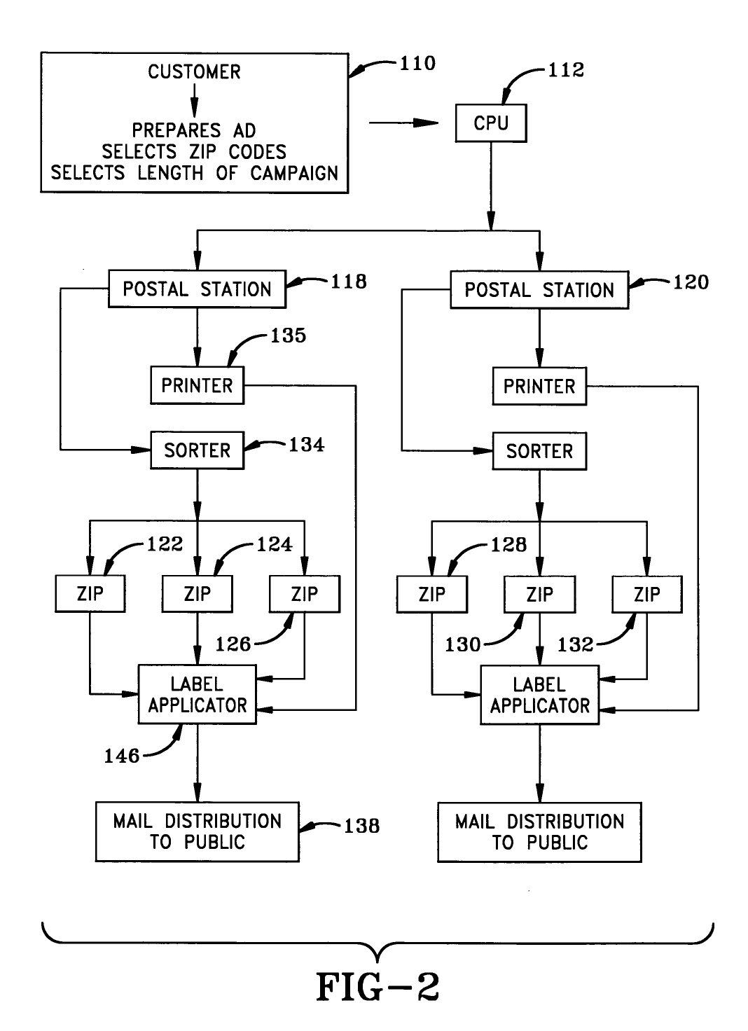

In a second embodiment of the invention, shown in FIG. 2, customer 110 prepares a suitable advertisement in a format which allows the image to be transmitted electronically. Customer 110 selects the various cities or zip codes for the areas in which they wish to advertise. Customer 110 contacts the CPU 112 and electronically forwards the advertisement to CPU 112 via the Internet. CPU 112 receives the electronic format of the advertisement and transmits the same to postal stations 118, 120 which will distribute mail to zip codes 122, 124, 126, 128,130 and 132. As with the previous embodiment, the customer may select to have an advertisement placed on mail at one or more zip codes or postal station 118 and one or more zip codes at postal station 120. So, for example, they may select to advertise in zip code 126 through postal station 118 and in zip codes 128 and 130 through postal station 120. At postal station 118 the advertisement is printed by a printer 135 onto labels for subsequent application to the mail once it is sorted by sorter 134. A label applicator machine 146 is physically connected into the mail sorting pathway. As the mail is sorted, or after the mail is sorted by sorter 134, the envelopes for delivery to the selected zip codes, 126 for example, will have a label adhesively applied to their outer surface by label applicator 146. The label may be printed on adhesive paper or an adhesive may be applied to the rear surface of the label as it passes through label applicator 146. The mail is then distributed 138 to the public located in zip codes 122, 124 and 126 in the normal manner, but only those consumers in zip code 126 receive individual pieces of mail with advertisements stuck to their outer surfaces. It will be understood that the advertisement may be printed onto a variety of sizes of labels which are designed to be applied to differently sized mail.

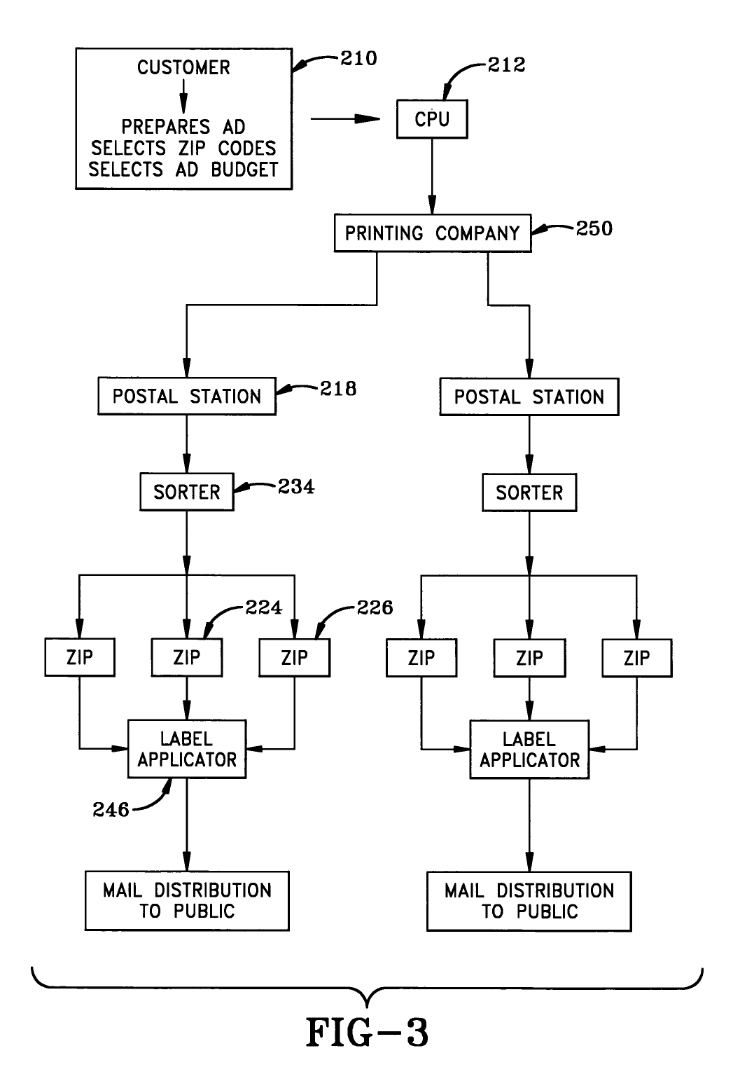

A third embodiment of the invention is shown in FIG. 3. In the third embodiment of the invention, customer 210 forwards the advertisement and other relevant information to an organization where the CPU 212 is based. CPU 212 transmits relevant information to the postal station 218 which delivers to the zip codes which customer 210 has preselected. CPU 212 transmits the advertisement to a printing company 250 which prints up a series of labels containing the desired advertisement. The labels are then shipped to postal station 218. The mail is sorted by sorter 234 and a label applicator 246 adhesively attaches the labels containing the advertisement to mail going to the selected zip codes, 224 and 226, for example. A scanner (not shown) may be provided in the system to ensure that the advertisement is not placed over relevant information such as delivery or return addresses.

It will be understood that the advertising system could be set up so that the customer can directly forward the advertisement to a CPU at a particular postal station related to a particular zip code instead of forwarding the advertisement to a CPU located at an advertising agency, business or central post office designated by the Postal Service.

It will also be understood that the program stored in the CPU for controlling the printing of the advertisements may include a variety of features relating to controlling the number of advertisements printed for a customer, the queuing and sequential selection of different advertisements for different customers that are to be sent to one particular zip code; and ensuring advertisements are printed by preselected dates so that time-sensitive advertisements are printed in a timely fashion etc.

It will also be understood that the system and method of providing time sensitive information could allow for more than one advertisement to be printed onto a single piece of mail and that graduated advertising rates could apply for single advertisements on single pieces of mail versus multiple advertisements on a single piece of mail.

It will also be understood that while the above description has covered the scenario where the customer has produced the advertisement, it will also be understood that an advertising agency or other company may produce the advertisement on the customer's behalf and may shepherd the advertisement through the system on the customer's behalf. Furthermore, it will be understood that if the advertisement is to be printed onto labels that will be adhesively applied to pieces of mail, that the organization which houses the CPU can print the labels themselves and then ship the labels to the relevant local postal station for application onto mail going to a particular zip code.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method of providing time sensitive information comprising the steps of:
applying an advertisement to an outer surface of a piece of mail after the piece of mail has been placed with a mail carrier; and
distributing the piece of mail to the party to whom it is addressed.

2. The method of providing time sensitive information as defined in claim 1, wherein the step of applying the advertisement to the piece of mail occurs at a postal station.

3. The method of providing time sensitive information as defined in claim 2, further comprising the steps of:
selecting at least one zip code in which to advertise;
applying the advertisement to a plurality of pieces of mail; and
distributing the pieces of mail to the parties to whom they are addressed.

4. The method of providing time sensitive information as defined in claim 3, further comprising the step of:
sorting the pieces of mail in a mail sorting machine.

5. The method of providing time sensitive information as defined in claim 4, wherein the step of applying the advertisement to the pieces of mail occurs after the step of sorting the pieces of mail in a sorting machine.

6. The method of providing time sensitive information as defined in claim 4, wherein the step of applying the advertisement to the pieces of mail occurs as the pieces of mail are sorted by the mail sorting machine.

7. The method of providing time sensitive information as defined in claim 3, wherein the step of applying the advertisement to the pieces of mail is accomplished by printing the advertisement directly on the outer surface of each of the pieces of mail.

8. The method of providing time sensitive information as defined in claim 7, further comprising the step of:
passing the pieces of mail individually through a scanner prior to the printing of the advertisement on the outer surface of each piece of mail.

9. The method of providing time sensitive information as defined in claim 3, wherein the step of applying the advertisement to the pieces of mail is accomplished by adhesively attaching a label containing the advertisement onto the outer surface of each piece of mail.

10. The method of providing time sensitive information as defined in claim 9, wherein the step of adhesively attaching labels to the pieces of mail is accomplished by way of a label applying machine which is operatively connected into a mail sorting pathway.

11. The method of providing time sensitive information as defined in claim 10, further comprising the step of passing the pieces of mail individually through a scanner prior to the step of adhesively attaching a label to the outer surface of the piece of mail.

12. The method of providing time sensitive information as defined in claim 1, further comprising the steps of:
producing the advertisement; and
transmitting the advertisement electronically to a central processing unit.

13. The method of providing time sensitive information as defined in claim 12, further comprising the step of electronically forwarding the advertisement from the central processing unit to a postal station for application to a plurality of pieces of mail.

14. The method of providing time sensitive information as defined in claim 13, further comprising the steps of:
selecting an area in which to advertise; and
forwarding the information relating to the advertising area to the central processing unit together with the advertisement.

15. The method of providing time sensitive information as defined in claim 14, wherein the step of selecting an area within which to advertise includes selecting at least one zip code to which mail is distributed.

16. The method of providing time sensitive information as defined in claim 15, further comprising the steps of:
selecting one or more of a length of advertising campaign, amount to be expended advertising, and number of pieces of mail on which to advertise; and
forwarding this selected information to the central processing unit along with the advertisement to be applied to the pieces of mail.

17. A method of providing time sensitive information comprising the steps of:
producing an advertisement;
selecting at least one zip code in which to advertise;
transmitting the advertisement and zip code to a postal station which that delivers mail to the zip code;
applying the advertisement to an outer surface of a plurality of pieces of mail; and
distributing the pieces of mail to addresses within the zip code.

18. The method of providing time sensitive information as claimed in claim 17, wherein the step of producing an advertisement includes producing an electronic version of the advertisement transmittable over the Internet.

19. The method of providing time sensitive information as claimed in claim 18, wherein the step of transmitting the advertisement and zip code further includes the intermediate step of forwarding the electronic version of the advertisement to a central processing unit remote from the postal station.

20. The method of providing time sensitive information as claimed in claim 19, wherein the central processing unit is located at an advertising agency.

21. The method of providing time sensitive information as claimed in claim 19, wherein the central processing unit is located at a central post office.

22. The method of providing time sensitive information as claimed in claim 17, wherein the step of applying the advertisement to the pieces of mail comprises the step of printing a plurality of labels for application to the outer surfaces of the pieces of mail.

23. The method of providing time sensitive information as claimed in claim 17, wherein the step of applying the advertisement to the pieces of mail further comprises the step of:
sorting the mail.

24. The method of providing time sensitive information as claimed in claim 17, wherein the step of applying the advertisement to the pieces of mail further comprises the steps of
providing a printer operatively connected to a sorting machine for sorting the pieces of mail;
forwarding the electronic version of the advertisement to the printer; and
printing the advertisement onto the outer surfaces of the pieces of mail.

25. A system for providing time sensitive information via the mail comprising;
a central processing unit;
a mail sorting machine;
an advertisement applicator selected from the group consisting of a printer and a label applicator; and
a mail distribution network.

26. The system for providing time sensitive information as defined in claim 25, further comprising a scanner.
